(19) United States
(12) Patent Application Publication
(10) Pub. No.: US 2022/0146471 A1
(43) Pub. Date: May 12, 2022

(54) WAVEFORM PROCESSING ASSISTANCE DEVICE AND WAVEFORM PROCESSING ASSISTANCE METHOD

(71) Applicant: SHIMADZU CORPORATION, Kyoto (JP)

(72) Inventors: Yuki ISHIKAWA, Kyoto (JP); Hiroaki KOZAWA, Kyoto (JP); Takeshi YOSHIDA, Kyoto (JP); Yuji KATSUYAMA, Kyoto (JP); Toshinobu YANAGISAWA, Kyoto (JP)

(21) Appl. No.: 17/518,750

(22) Filed: Nov. 4, 2021

(30) Foreign Application Priority Data
Nov. 9, 2020 (JP) 2020-186860

(51) Int. Cl. G01N 30/86

(52) U.S. Cl. CPC G01N 30/8631; G06F 3/14; G01N 30/8637

(57) ABSTRACT

A waveform processing assistance device includes an acquirer that acquires a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter, a determiner that determines robustness of each value of the waveform processing parameter based on a plurality of peak separation information pieces acquired by the acquirer, and a display controller that causes the display to display a plurality of peak separation information pieces acquired by the acquirer and a robustness information piece representing robustness of each value of the waveform processing parameter that is calculated by the determiner.

### BACKGROUND

### Technical Field

The present invention relates to a waveform processing assistance device and a waveform processing assistance method.

### Description of Related Art

Waveform processing is executed to separate each peak from a waveform data piece obtained as an analysis result by various analysis devices. For example, in a chromatograph, a chromatogram is obtained as a waveform data piece. Further, in a mass spectrometer, a mass spectrum is obtained as a waveform data piece. A value of a waveform processing parameter is set for separation of each peak from a waveform data piece. As waveform processing parameters, “Width,” “Slope” and so on are used (see JP 2015-59782 A). “Width” is the smallest full width at half maximum that is used to determine a peak in waveform processing. Further, “Slope” is a value of inclination of a critical peak for determination of a rising position and a falling position of a peak. A user separates each peak from a waveform data piece by setting values of one type or a plurality of types of waveform processing parameters. As a result of waveform processing, a peak section, a peak intensity, a peak area and so on are obtained.

### SUMMARY

In the above-mentioned waveform processing, a result of waveform processing in regard to each peak differs depending on a value of a waveform processing parameter to be set by the user. For example, in a case where a value of a waveform processing parameter is inappropriate, a plurality of peaks may be detected as one peak or noise may be detected as a peak. Therefore, the user is required to appropriately determine a value of a waveform processing parameter. However, it is not easy to appropriately determine a value of a waveform processing parameter.

Further, even in a case where the same sample is analyzed multiple times by the same analysis device under the same condition, a position or a shape of the same peak in a waveform data piece may differ depending on accuracy of the analysis device, deterioration of a separation column, etc. In a case where an area, an intensity or the like of the same peak differs, accuracy of a quantitative analysis is degraded. Therefore, even in a case where a waveform data piece changes subtly due to accuracy of the analysis device, deterioration of the separation column, etc., it is desired to determine a value of a waveform processing parameter which has high robustness and with which the same result of waveform processing can be obtained.

An object of the present invention is to provide a waveform processing assistance device and a waveform processing assistance method that enables easy determination of a value of a waveform processing parameter which has high robustness and with which an appropriate result of waveform processing can be obtained.

A waveform processing assistance device according to one aspect of the present invention that assists waveform processing of separating a peak from a waveform data piece representing an analysis result of an analysis device based on a value of a waveform processing parameter using a display, includes an acquirer that acquires a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter, a determiner that determines robustness of each value of the waveform processing parameter based on the plurality of peak separation information pieces acquired by the acquirer, and a display controller that causes the display to display the plurality of peak separation information pieces acquired by the acquirer and a robustness information piece representing robustness of each value of the waveform processing parameter that is calculated by the determiner.

A waveform processing assistance method according to another aspect of assisting waveform processing of assisting waveform processing of separating a peak from a waveform data piece representing an analysis result of an analysis device based on a value of a waveform processing parameter using a display includes acquiring a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter, determining robustness of each value of the waveform processing parameter based on a plurality of acquired peak separation information pieces, and causing the display to display a plurality of acquired peak separation information pieces and a robustness information piece representing robustness of each value of the determined waveform processing parameter.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a block diagram showing the configuration of an analysis system including a waveform processing assistance device according to one embodiment of the present invention;

FIG. 2 is a diagram for explaining a waveform processing parameter and waveform processing;

FIG. 3 is a diagram for explaining a waveform processing parameter and the waveform processing;

FIG. 4 is a diagram for explaining a waveform processing parameter and the waveform processing;

FIG. 5 is a diagram for explaining a waveform processing parameter and the waveform processing;

FIG. 6 is a diagram showing the configuration of the waveform processing assistance device;

FIG. 7 is a flowchart showing one example of behavior of the waveform processing assistance device of FIG. 6;

FIG. 8 is a flowchart showing the one example of behavior of the waveform processing assistance device of FIG. 6;

FIG. 9 is a flowchart showing the one example of behavior of the waveform processing assistance device of FIG. 6;

FIG. 10 is a diagram showing one example of an operation image displayed in a screen of a display by the waveform processing assistance device of FIG. 6;

FIG. 11 is a diagram showing one example of an operation image displayed in the screen of the display by the waveform processing assistance device of FIG. 6;

FIG. 12 is a diagram showing one example of an operation image displayed in the screen of the display by the waveform processing assistance device of FIG. 6;

FIG. 13 is a diagram showing one example of an operation image displayed in the screen of the display by the waveform processing assistance device of FIG. 6;

FIG. 14 is a diagram showing one example of an operation image displayed in the screen of the display by the waveform processing assistance device of FIG. 6;

FIG. 15 is a diagram showing one example of an operation image displayed in the screen of the display by the waveform processing assistance device of FIG. 6;

FIG. 16 is a diagram showing a display example of a reproduciability information piece; and

FIG. 17 is a diagram showing a display example of the reproduciability information piece.

### DETAILED DESCRIPTION

A waveform processing assistance device and a waveform processing assistance method according to embodiments of the present invention will be described below in detail with reference to the drawings.

### (1) Configuration of Analysis System

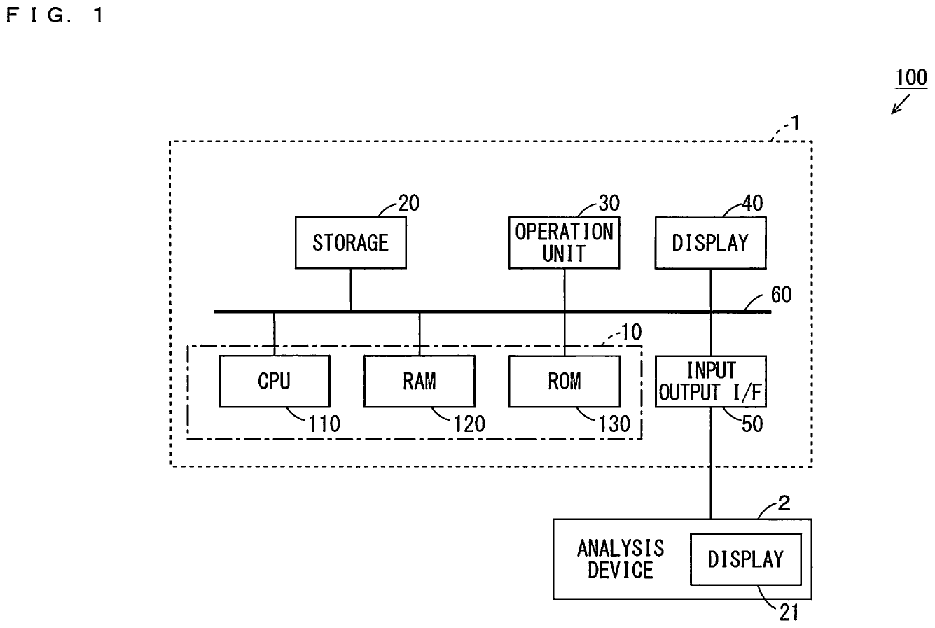

FIG. 1 is a block diagram showing the configuration of an analysis system including the waveform processing assistance device according to one embodiment of the present invention. As shown in FIG. 1, the analysis system 100 includes a control device 1 and an analysis device 2.

The control device 1 is constituted by a CPU (Central Processing Unit) 110, a RAM (Random Access Memory) 120, a ROM (Read Only Memory) 130, a storage 20, an operation unit 30, a display 40 and an input output I/F (interface) 170. The CPU 110, the RAM 120, the ROM 130, the storage 20, the operation unit 30, the display 40 and the input output I/F 50 are connected to a bus 60. The CPU 110, the RAM 120 and the ROM 130 constitute the waveform processing assistance device 10. Details of the waveform processing assistance device 10 will be described below.

The RAM 120 is used as a work area for the CPU 110. A system program is stored in the ROM 130. The storage 20 includes a storage medium such as a hard disc or a semiconductor memory. A waveform processing assistance program is stored in the storage 20. The waveform processing assistance program is a computer program for execution of waveform processing assistance behavior by the waveform processing assistance device 10. The waveform processing assistance program may be stored in the ROM 130 or an external storage device.

The CPU 110 executes the waveform processing assistance program stored in the storage 20 or the like on the RAM 120, whereby the waveform processing assistance behavior is executed. The waveform processing assistance behavior will be described below.

The operation unit 30 is an input device such as a keyboard, a mouse or a touch panel and is operated by a user to provide a predetermined instruction to the waveform processing assistance device 10. The display 40 is a display device such as a liquid crystal display device. The input output I/F 50 is connected to the analysis device 2.

The analysis device 2 may be a chromatograph such as a liquid chromatograph, a gas chromatograph or a supercritical fluid chromatograph, or may be a mass spectrometer or the like. In the present embodiment, the analysis device 2 is a liquid chromatograph. The analysis device 2 has a display 21.

The analysis device 2 generates a waveform data piece representing an analysis result. In a case where the analysis device 2 is a chromatograph, a waveform data piece is a chromatogram. The abscissa of a chromatogram indicates an elution time (retention time), and the ordinate indicates an intensity of signal. In a case where the analysis device 2 is a mass spectrometer, a waveform data piece is a mass spectrum. The abscissa of a mass spectrum indicates a mass-to-charge ratio (m/z), and the ordinate indicates an intensity of signal. The abscissa of a waveform data piece is referred to as a position. The ordinate of a waveform data piece is referred to as intensity. A waveform data piece in the present embodiment is a chromatogram.

### (2) Waveform Processing Parameter and Result of Waveform Processing

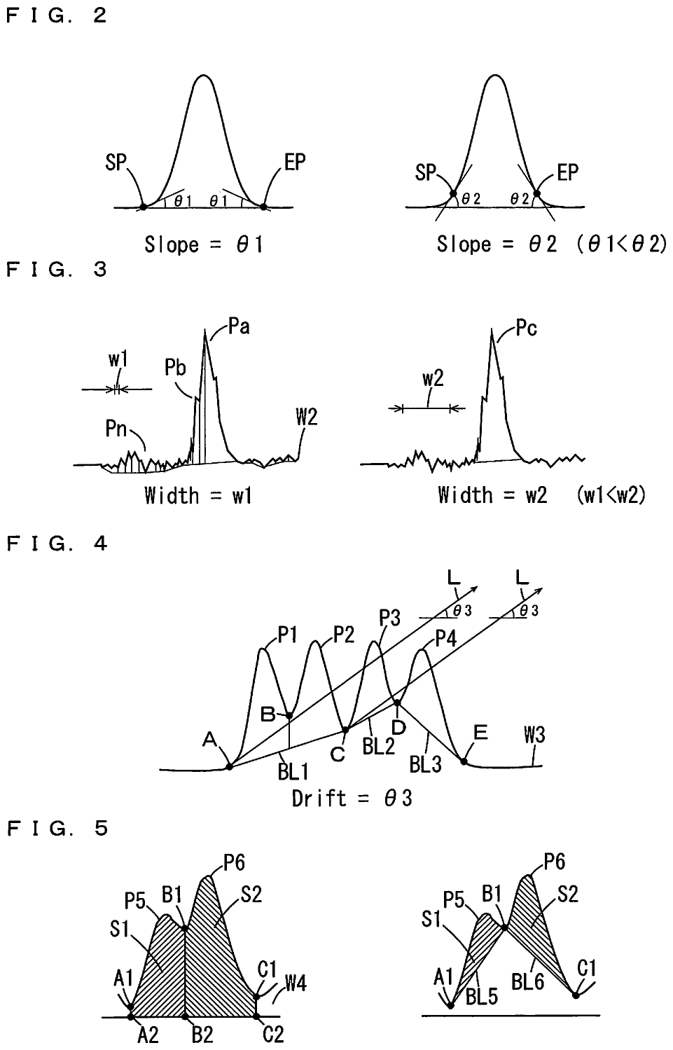

Waveform processing is executed on a waveform data piece that has been supplied to the waveform processing assistance device 10 in order to separate a peak based on values of one or a plurality of types of waveform processing parameters. Here, a waveform processing parameter and waveform processing will be described. FIGS. 2 to 5 are diagrams for explaining a waveform processing parameter and waveform processing. In the present embodiment, “Slope,” “Width,” “Drift” and a peak separation method are used as waveform processing parameters. The peak separation method includes vertical division, complete separation (baseline separation), complete separation in tailing or leading, etc.

FIG. 2 shows results of waveform processing in a case where values of “Slope” are different. “Slope” (unit: μV/min) is a threshold value of inclination for detection of a peak start point SP and a peak end point EP and represents sensitivity of peak detection. In the example in the left field of FIG. 2, the value of “Slope” is set to 01. In the example of the right field of FIG. 2, the value of “Slope” is set to 02 that is larger than 01.

In a case where the waveform processing is executed based on a value of “Slope,” a position at which inclination of a waveform extending from the left baseline to a peak is the value of “Slope” is detected as a peak start point SP. Further, a position at which inclination of the waveform extending from the peak to the right baseline is the value of “Slope” is detected as a peak end point EP. In this manner, when values of “Slope” are different, the peak start points SP to be detected are different, and the peak end points EP to be detected are different.

FIG. 3 shows results of waveform processing in a case where the values of “Width” are different. “Width” (unit: sec) is the smallest value of half value width of a peak to be detected. In the example in the left field of FIG. 3, the value of “Width” is set to w1. In the example in the right field of FIG. 3, the value of “Width” is set to w2 that is larger than w1.

In a case where the waveform processing is executed based on the value of “Width,” all of peaks having values that are equal to or larger than the half value width w1 are detected. For example, a peak Pa and a peak Pb are separated. On the other hand, noise is detected as a peak Pn. In the example in the right field of FIG. 3, only a peak Pc having a value that is equal to or larger than the half value width w2 is detected. For example, two adjacent peaks that partially overlap with each other are detected as one peak. On the other hand, noise n is not detected as a peak.

In this manner, in a case where the value of “Width” is set to a large value, noise can be prevented from being detected as a peak. On the other hand, in a case where the value of “Width” is too large, adjacent peaks that partially overlap with each other may be detected as one peak.

FIG. 4 shows differences in peak separation method depending on values of “Drift.” Drift (Unit: μV/min) is a threshold value for a variation in baseline. FIG. 4 shows a plurality of peaks P1, P2, P3, P4 and a plurality of local minimum points (valley between peaks) A, B, C, D, E. In the example of FIG. 4, the value of “Drift” is set to 63.

In a case where waveform processing is executed based on the value of “Drift,” Drift setting lines L respectively passing through local minimum points and having an inclination of θ3 are drawn. For example, the local minimum point B is located at a position farther upward than the Drift setting line passing through the local minimum point A. In this case, the straight line connecting the local minimum points A, B to each other is not considered as a baseline. In contrast, the local minimum point C is located at a position farther downward than the drift setting line L passing through the local minimum point A. In this case, a baseline correction line BL1 connecting the local minimum points A, C to each other is set. This vertically divides the peaks P1, P2 at the local minimum point B. The local minimum point D is located at a position farther downward than the Drift setting line passing through the local minimum point C. In this case, a baseline correction line BL2 connecting the local minimum points C, D to each other is set. This completely separates the peak P3. Similarly, the local minimum point E is located at a position farther downward than the Drift setting line (not shown) passing through the minimum line D. In this case, a baseline correction line BL3 connecting the local minimum points D, E to each other is set. This completely separates the peak 4.

In a case where the value of “Drift” is set to a small value, each peak is likely to be vertically divided. On the other hand, in a case where the value of “Drift” is set to a large value, each peak is likely to be completely separated. In this manner, peak separation methods can be different depending on the value of “Drift.”

Here, the peak separation method will be described. The peak separation method (vertical division/complete separation) may be set as a waveform processing parameter or may be obtained as a result of waveform processing in depending on a value of “Drift.” In the present embodiment, the peak separation method includes vertical division and complete separation. In the examples in the left field and right field of FIG. 5, adjacent peaks P5, P6 that partially overlap with each other are shown.

The example in the left field of FIG. 5 shows vertical division. In vertical division, a straight line A1-A2, a straight line B1-B2 and a straight line C1-C2 that extend respectively and orthogonally to the abscissa from the local minimum points A1, B1, C1 are set. Peaks P5, P6 are respectively separated by the straight line A1-A2, the straight lines B1-B2 and the straight line C1-C2. An area of the peak P5 is an area of a region surrounded by the curve connecting the local minimum point A and the local minimum point B to each other, the straight line A1-A2, the straight line B1-B2 and the abscissa. An area of the peak P6 is an area of a region surrounded by the curve connecting the local minimum point B1 and the local minimum point C1 to each other, the straight line B1-B2, the straight line C1-C2 and the abscissa.

The example in the right field of FIG. 5 shows complete separation. In complete separation, a baseline assistance line BL5 connecting adjacent local minimum points A1, B1 is set, and a baseline assistance line BL6 connecting adjacent local minimum points B1, C1 is set. Peaks P5, P6 are respectively separated by the baseline assistance lines BL5, BL6. An area of the peak P5 is an area of a region surrounded by the curve connecting the local minimum point A1 and the local minimum point B1 to each other and the baseline assistance line BL5. An area of the peak P6 is an area of a region surrounded by the curve connecting the local minimum point B1 and the local minimum point C1 to each other and the baseline assistance line BL6.

In this manner, the area of a peak separated by vertical division is larger than the area of a peak separated by complete separation. Therefore, in a case where a component corresponding to a peak is quantitatively analyzed, a peak of the same component is desirably separated by the same separation method.

A value of a waveform processing parameter is not limited to a numerical value and also includes an identification information piece for specifying whether the peak separation method is vertical division or complete separation. Such an identification information piece is represented by a digital value in the CPU 110.

Here, a result of waveform processing obtained by the waveform processing in the present embodiment will be described. A result of waveform processing is obtained by separation of each peak from a waveform data piece based on set values of one or a plurality of types of waveform processing parameters. A result of waveform processing includes a position of a peak start point, an intensity at a peak start point, a position of a peak end point, an intensity at a peak end point, a position of a peak top, an intensity at a peak top, a peak area, an SN (signal noise ratio), a type of the peak separation method (vertical division/complete separation), etc.

### (3) Functional Configuration of Waveform Processing Assistance Device 10

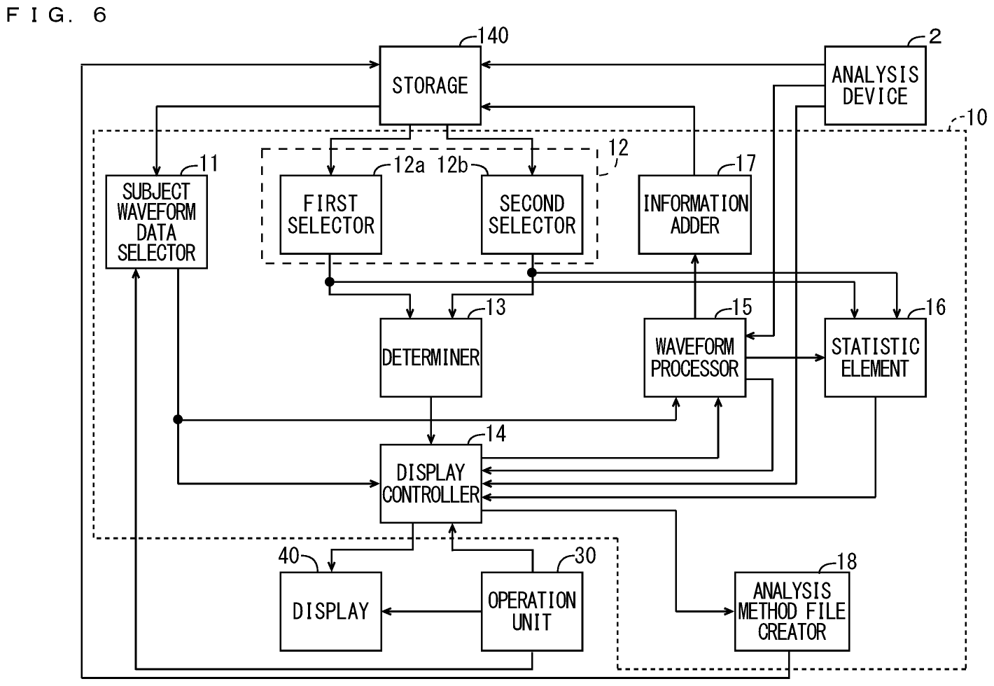

FIG. 6 is a diagram showing the waveform processing assistance device 10. First, the waveform processing assistance device 10 includes a subject waveform data selector 11, an acquirer 12, a determiner 13, a display controller 14, a waveform processor 15, a statistic element 16, an information adder 17 and an analysis method file creator 18 as functions. In the present embodiment, each constituent element (11-18) of the waveform processing assistance device 10 is implemented by execution of the waveform processing assistance program stored in the ROM 130 or the storage 20 by the CPU 110 of FIG. 1. Part or all of the constituent elements (11-18) of the waveform processing assistance device 10 may be implemented by hardware such as an electronic circuit.

In the storage 20, one or a plurality of waveform processing data pieces obtained by the analysis device 2 are stored. In the present example, a waveform data piece obtained by the analysis device 2 is subject to the waveform processing. A waveform data piece that is subject to the waveform processing is referred to as a subject waveform data piece.

Further, an information piece representing a correspondence relationship between a value of a waveform processing parameter and a result of waveform processing in regard to each peak of one or a plurality of waveform data pieces is referred to as a peak separation information piece. In the storage 20, one or a plurality of peak separation information pieces in regard to one or a plurality of peaks are stored. In the present embodiment, a plurality of peak separation information pieces are stored in advance in the storage 20.

The subject waveform data selector 11 selects a subject waveform data piece from one or a plurality of waveform data pieces stored in the storage 20 and supplies the selected subject waveform data piece to the display controller 14 and the waveform processor 15.

The acquirer 12 includes a first selector 12a and a second selector 12b. The acquirer 12 acquires part or all of the peak separation information pieces from among the plurality of peak separation information pieces stored in the storage 20.

The first selector 12a selects one or a plurality of peak separation information pieces that satisfy a predetermined selection condition from among the plurality of peak separation information pieces stored in the storage 20. In the present embodiment, the first selector 12a selects a plurality of peak separation information pieces corresponding to peaks that are present at the same position or in the same section from among the plurality of peak separation information pieces stored in the storage 20, for example.

The second selector 12b selects one or a plurality of peaks having a shape similar to the shape of a representative peak in a subject waveform data piece from among the plurality of peak separation information pieces stored in the storage 20. A representative peak is a peak selected by the user from among a plurality of peaks in the subject waveform data piece. The second selector 12b extracts a feature from a plurality of peaks and a representative peak corresponding to the plurality of peak separation information pieces stored in the storage 20 and selects one or a plurality of peaks having a shape similar to the shape of the representative peak using a clustering method such as hierarchical clustering based on the extracted feature. As features, an intensity of each peak, an intensity of valley between adjacent peaks, intensities of adjacent peaks, resolutions of adjacent peaks or the like can be used. The second selector 12b may include a feature extractor that uses machine learning.

Hereinafter, a peak separation information piece selected by the first selector 12a or the second selector 12b is referred to as a selection peak separation information piece. Further, a peak corresponding to a selection peak separation information piece is referred to as a selection peak. The first selector 12a and the second selector 12b may classify a plurality of selection peak separation information pieces in accordance with types of peak separation methods. For example, the first selector 12a and the second selector 12b may classify a plurality of selection peak separation information pieces into a cluster of a plurality of selection peak separation information pieces corresponding to a plurality of peaks separated by vertical division and a cluster of a plurality of selection peak separation information pieces corresponding to a plurality of peaks separated by complete separation.

The determiner 13 calculates reproduciability of a result of waveform processing corresponding to each value of a waveform processing parameter based on a plurality of selection peak separation information pieces and determines robustness of each value based on the calculated reproduciability. Specifically, the larger the number of times the same or approximate result of waveform processing is obtained in a case where the waveform processing is executed using the same value as a waveform processing parameter in the plurality of selection peak separation information pieces, the higher the reproduciability of the result of waveform processing is. Reproduciability of a result of waveform processing is expressed by a relative standard deviation ((standard deviation/an average value)×100) of a peak area, for example. Further, reproduciability of a result of waveform processing may be expressed by Intersection over union (IoU) of an area of a peak processed with use of an original waveform processing parameter and an area of a peak processed with use of a new waveform processing parameter. In a case where values of a waveform processing parameter that can obtain high reproduciability of a result of waveform processing are arranged, the center portion of arranged values of the waveform processing parameters has higher robustness than the end portions of the arranged values. Hereinafter, an information piece representing a result of determination of robustness of each value of a waveform processing parameter calculated by the determiner is referred to as a robustness information piece.

The display controller 14 causes the display 40 to display a subject waveform data piece selected by the subject waveform data selector 11. Further, the display controller 14 causes the display 40 to display a selection peak separation information piece and a selection peak supplied from the first selector 12a or the second selector 12b and causes the display 40 to display a robustness information piece supplied from the determiner 13.

The user determines values of one or a plurality of types of waveform processing parameters to be set for execution of the waveform processing on a subject waveform data piece by viewing the selection peak separation information piece, the selection peak and the robustness information piece displayed in the display 40. The user sets a determined value of each waveform processing parameter in the waveform processor 15 by operating the operation unit 30. Further, the user can set a value of a waveform processing parameter for each of a plurality of sections in the abscissa of a subject waveform data piece. In this case, the waveform processing is executed for each section based on a value of a waveform processing parameter that is set for each section.

The waveform processor 15 executes the waveform processing on a subject waveform data piece based on values of one or a plurality of types of waveform processing parameters that are set by an operation of the operation unit 30. As a result, a result of waveform processing is obtained in regard to each peak in the subject waveform data piece. Thus, a new peak separation information piece is obtained. A result of waveform processing in regard to each peak in a waveform data piece is displayed in the display 40 by the display controller 14. The user can manually correct a result of waveform processing displayed in the display 40. For example, the user can correct the positions of a peak start point and a peak end point displayed in the display 40 using the operation unit 30. In this case, the waveform processor 15 calculates a value of a waveform processing parameter for acquirement of a corrected result of waveform processing based on the plurality of peak separation information pieces stored in the storage 20. Thus, a corrected result of waveform processing and a calculated value of a waveform processing parameter are obtained as new peak separation information pieces.

Further, in a case where the waveform processing is executed for each section of a subject waveform data piece based on different values of a waveform processing parameter, the waveform processor 15 executes the waveform processing on a subject waveform data piece using a plurality of values of a waveform processing parameter set for a plurality of sections. Thus, a plurality of results of waveform processing corresponding to a plurality of values of a waveform processing parameter are obtained in regard to each peak in each section. In this case, a plurality of new peak separation information pieces are obtained in regard to each peak.

The statistic element 16 calculates a statistic of a plurality of results of waveform processing in regard to any peak of a plurality of waveform data pieces obtained when an analysis is performed multiple times in regard to the same sample. A statistic refers to the average value, the largest value, the smallest value and so on of a plurality of results of waveform processing, for example. For example, the statistic element 16 calculates the average value, the largest value, the smallest value or the like of areas of a plurality of selection peaks, peak start points, peak end points, intensities of a peak top or the like in a plurality of waveform data pieces as a statistic. In the present embodiment, the statistic element 16 calculates the average value, the largest value and the smallest value of areas of a plurality of selection peaks, the largest value and the smallest value of a start point of each selection peak, and the largest value and the smallest value of an end point of each selection peak. A statistic calculated by the statistic element 16 is displayed in the display 40 by the display controller 14.

The information adder 17 adds a new peak separation information piece obtained by the waveform processor 15 to the storage 20. Thus, the number of a plurality of peak separation information pieces stored in the storage 20 increases cumulatively.

The analysis method file creator 18 creates an analysis method file that defines a condition of sample analysis to be performed by the analysis device 2 and a condition of waveform processing for a waveform data piece.

### (4) Behavior of Waveform Processing Assistance Device 10

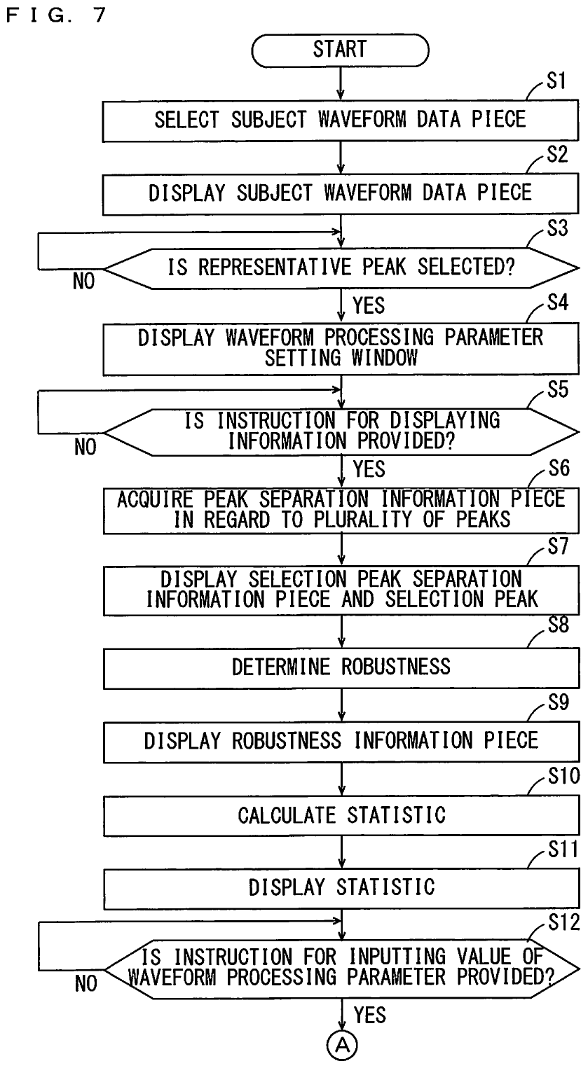

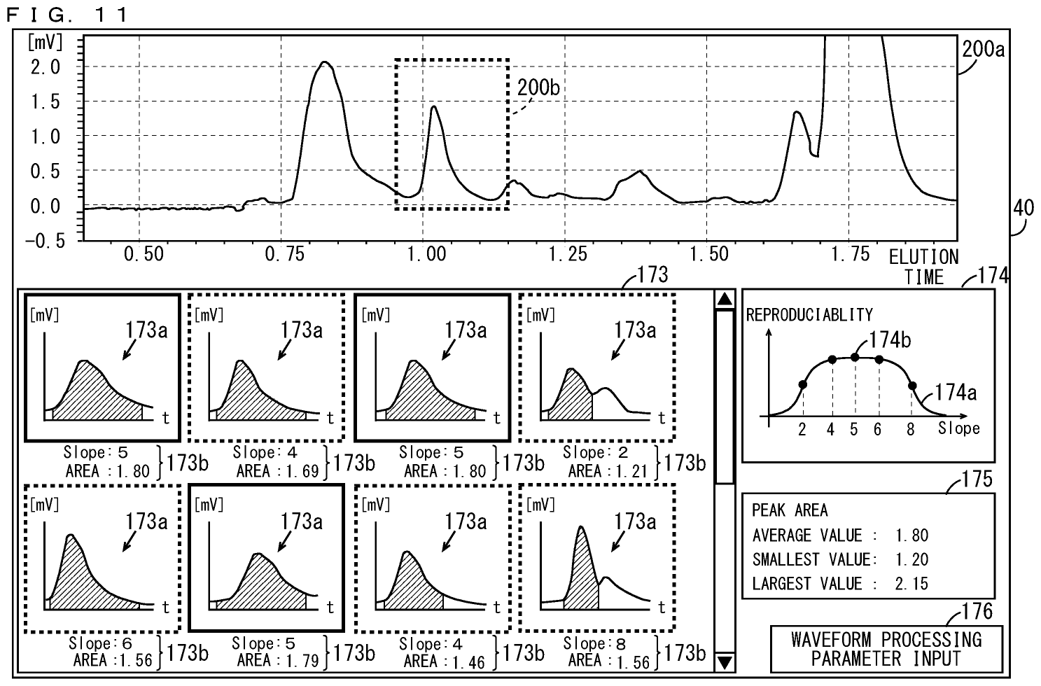

FIGS. 7 to 9 are flowcharts showing one example of the behavior of the waveform processing assistance device 10 of FIG. 6. FIGS. 10 to 15 are diagrams showing one example of operation images to be displayed on a screen of the display 40 by the waveform processing assistance device 10 of FIG. 6. In the present example, the user determines an appropriate value of “Slope” which is a waveform processing parameter. Values of other types of waveform processing parameters are fixed to default values or other values. In the following example, the analysis device 2 is a chromatograph. Therefore, a waveform data piece is a chromatogram.

First, the subject waveform data selector 11 selects a subject waveform data piece from among a plurality of waveform data pieces stored in the storage 20 (the step S1 of FIG. 7). The display controller 14 causes the display 40 to display a selected subject waveform data piece (step S2). In the example of FIG. 10, a subject waveform data piece 200a is displayed in an upper portion of the screen of the display 40.

The user selects one representative peak 200b on the screen from among a plurality of peaks included in the subject waveform data piece 200a using the operation unit 30. The display controller 14 determines whether the representative peak 200b has been selected by the user (step S3). In a case where the representative peak 200b is not selected by the user, determination of the step S3 is repeated.

When the representative peak 200b is selected, the display controller 14 causes the display 40 to display a waveform processing parameter setting window 161 (step S4). In the example of FIG. 10, the waveform processing parameter setting window 161 is displayed in a lower portion on the screen of the display 40. The waveform processing parameter setting window 161 includes input fields 162 to 164, selection buttons 165 to 170, an information display button 171 and a waveform processing execution button 172.

Values of “Slope,” “Width” and “Drift” are input in the input fields 162 to 164. The selection button 165 is selected in a case where the peak separation method is set to vertical division. The selection button 166 is selected in a case where the peak separation method is set to complete separation. In a case where a value of “Drift” is set, the peak separation method is determined automatically. Therefore, in a case where a value of “Drift” is input in the input field 164, the selection buttons 165 and 166 cannot be selected. Further, in a case where either one of the selection buttons 165 and 166 is selected, a value of “Drift” in the input field 164 is ignored.

The selection button 167 is used to provide an instruction for execution of behavior of the first selector 12a of FIG. 6. In a case where the selection button 167 is selected, the behavior of the first selector 12a is executed. In the present example, a selection condition for the selection performed by the first selector 12a is an elution time. In this case, peak separation information pieces in regard to a plurality of peaks in the same range of elution time as a representative peak are selected from among a plurality of peak separation information pieces.

The selection button 168 is used to provide an instruction for executing the behavior of the second selector 12b of FIG. 6. In a case where the selection button 168 is selected, the behavior of the second selector 12b is executed. In this case, peak separation information pieces in regard to a plurality of peaks having the same or similar shape as the shape of the representative peak are selected from among a plurality of peak separation information pieces.

The selection button 169 is selected to cause the display 40 to display a robustness information piece. The selection button 170 is selected to cause the display 40 to display a statistic. The information display button 171 is used to provide an instruction for displaying an information piece designated by a selection button selected from among the selection buttons 167 to 170. The waveform processing execution button 172 is used to provide an instruction for executing the waveform processing in regard to the subject waveform data piece 200a.

In the present example, the user inputs values of “Width” and “Drift” in the input field 163 and the input field 164. The user may use default values that are input in advance in the input field 163 and the input field 164. In this case, the selection button 165 and the selection button 166 cannot be selected. Subsequently, the user selects at least one of the selection button 167 and the selection button 168. In the present example, both of the selection button 167 and the selection button 168 are selected. In this state, the display controller 14 determines whether an instruction for displaying an information piece has been provided (step S5). In the present example, whether the information display button 171 of FIG. 10 has been operated is determined.

In a case where an instruction for displaying an information piece has been provided, the acquirer 12 acquires a plurality of peak separation information pieces stored in the storage 20 (step S6). In the present example, because the selection buttons 167, 168 of FIG. 10 are selected, a plurality of peaks that are in the same range of elution time as the representative peak 200b and has the shape that is the same as or similar to the shape of the representative peak are selected, and a plurality of peak separation information pieces corresponding to the plurality of selected peaks are selected.

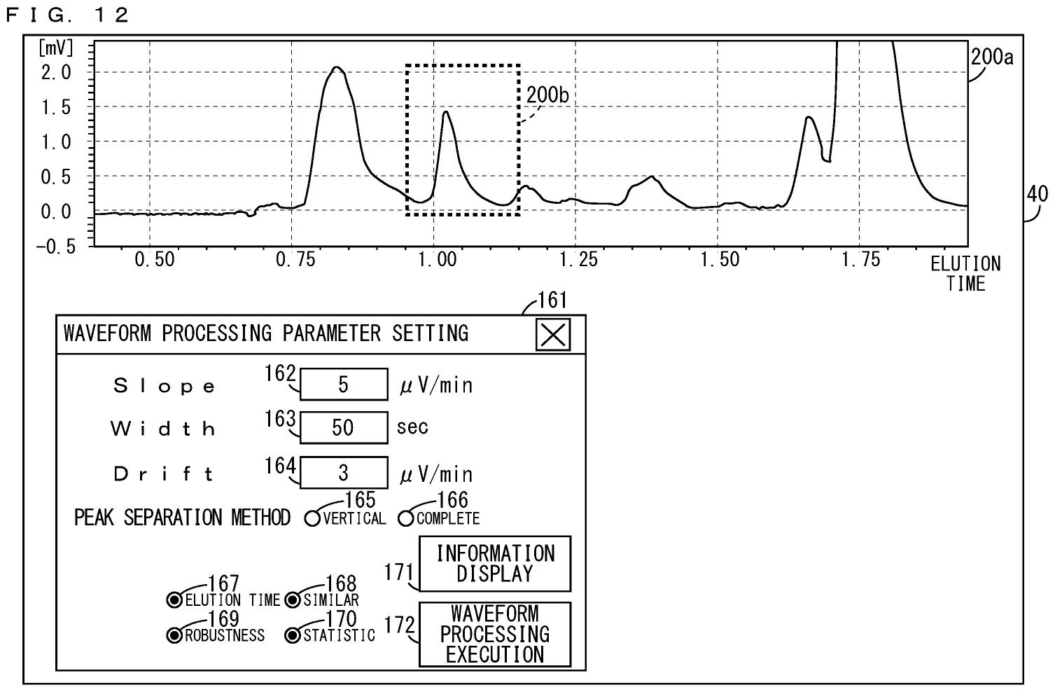

The display controller 14 causes the display 40 to display one or a plurality of peaks and one or a plurality of peak separation information pieces acquired by the acquirer 12 as one or a plurality of selection peaks and one or a plurality of peak separation information pieces (step S7). In the present example, as shown in FIG. 11, the shapes of a plurality of selection peaks 173a and a plurality of selection peak separation information pieces 173b are displayed in the peak separation information display window 173. Each selection peak separation information piece 173b includes a value of “Slope” as a value of a waveform processing parameter and includes a peak area as a result of waveform processing. A range to which hatching is applied in each selection peak 173a is a section of a peak separated from a waveform data piece by the waveform processing.

The user can view the peak separation information display window 173 displayed in the screen and determine which value of a waveform processing parameter is a value with which a result of waveform processing that is considered to be appropriate is to be obtained. For example, the user may consider that a result of waveform processing (a peak area and a peak section in the present example) obtained in a case where “Slope” is 4, 5 or 6 is appropriate.

Further, the determiner 13 determines robustness of each value of a waveform processing parameter in the plurality of selection peak separation information piece 173b (step S8). Specifically, the determiner 13 calculates reproduciability of each value of a waveform processing parameter of the plurality of selection peak separation information pieces 173b and calculates robustness of a value of the waveform processing parameter based on the reproduciability. The display controller 14 causes the display 40 to display a result of determination obtained by the determiner 13 as a robustness information piece (step S9). In the present example, as shown in FIG. 11, the robustness information piece 174 is displayed on the screen of the display 40. The abscissa of the robustness information piece 174 of FIG. 11 indicates a value of “Slope,” and the ordinate indicates reproduciability of a result of waveform processing of “Slope.” The robustness information piece 174 is displayed as a reproduciability curve 174a representing a relative standard deviation, for example.

In a case where finding a plurality of values of a waveform processing parameter that are considered to be appropriate, the user can view the robustness information piece 174 and determine a value having the highest robustness from among the plurality of values of the waveform processing parameter. According to the robustness information piece 174 of FIG. 11, reproduciability of a result of waveform processing is the highest in a case where the value of “Slope” is set to 4, 5 or 6. In arrangement of values of waveform processing parameters having high reproduciability, it is considered that a value in the center portion has higher robustness than the values at both ends. In the example of FIG. 11, the value of “Slope” at a point 174b which is in the center of the range and has the highest reproduciability is 5. In this case, the user can determine that robustness is high in a case where the value of “Slope” is 5.

Further, when the user selects the point 174b of the robustness information piece 174, the selection peak 173a obtained in a case where the value of “Slope” is 5 is surrounded by the thick solid frame among the plurality of selection peaks 173a in the peak separation information display window 173. Thus, the user can re-confirm the selection peak 173a and the selection peak separation information piece 173b corresponding to the selected value of the waveform processing parameter.

The statistic element 16 calculates the statistic of a plurality of results of waveform processing obtained in a case where the same value of a waveform processing parameter is used based on a plurality of selection peak separation information pieces (step S10). The display controller 14 causes the display 40 to display the statistic calculated by the statistic element 16 (step S11). In the present example, as shown in FIG. 11, a statistic 175 of a plurality of selection peaks is displayed on the screen of the display 40. In the example of FIG. 11, the average value, the smallest value and the largest value of a peak area in regard to the plurality of selection peaks 173a displayed in the peak separation information display window 173 are displayed. Thus, the user can conjecture an appropriate value and an appropriate range of the waveform processing parameter based on the statistic 175.

The user determines a value that is appropriate as a value of the waveform processing parameter and has high robustness based on the peak separation information display window 173, the robustness information piece 174 and the statistic 175. In the example of FIG. 11, the user determines 5 as the value of “Slope.”

In the example of FIG. 11, a waveform processing parameter input button 176 is displayed on the screen of the display 40. The display controller 14 determines whether an instruction for inputting a value of a waveform processing parameter has been provided (step S12). In the present example, whether the waveform processing parameter input button 176 has been operated with use of the operation unit 30 is determined. In a case where an instruction for inputting a value of a waveform processing parameter is not provided, the display controller 14 repeats determination of the step S12.

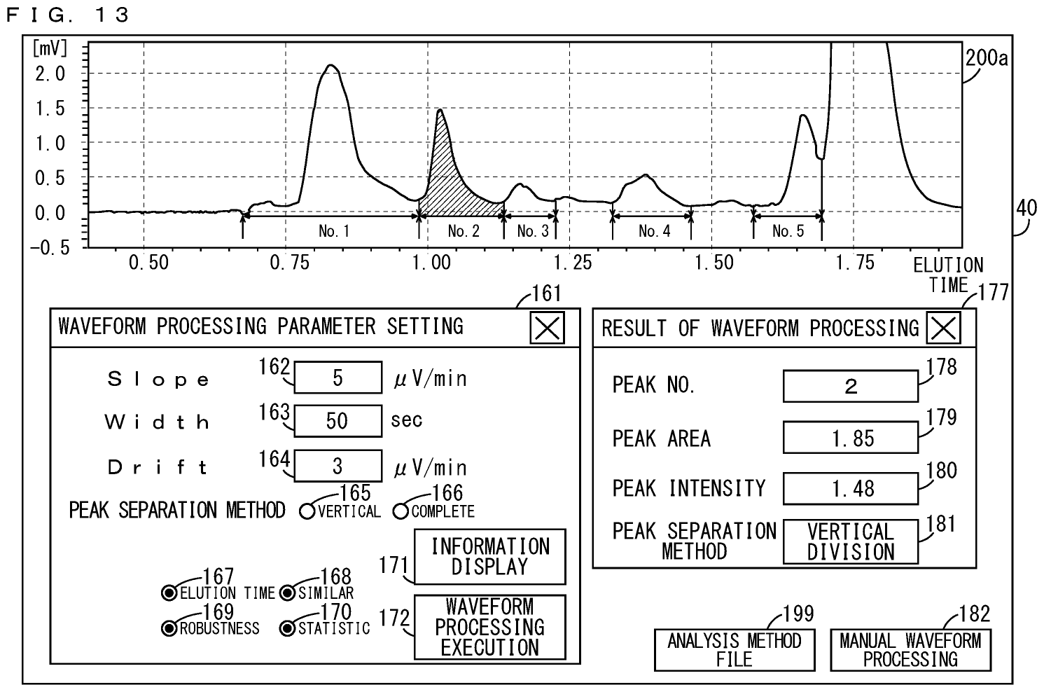

In a case where an instruction for inputting a value of a waveform processing parameter is provided, the display controller 14 displays the waveform processing parameter setting window 161 on the screen of the display 40 as shown in FIG. 12. The user inputs a determined value of a waveform processing parameter in the input field 162. In the present example, the user inputs 5 in the input field 162 as the value of “Slope.” Thus, the value of “Slope” is set to 5. Alternatively, the user designates a value of a waveform processing parameter in the robustness information piece 174 of FIG. 11, whereby the designated value may be input in the input field 162. Further, the user designates one selection peak separation information piece 171a in the peak separation information display window 173 of FIG. 11, whereby the value of the waveform processing parameter of the designated selection peak separation information piece 171a may be input in the input field 162.

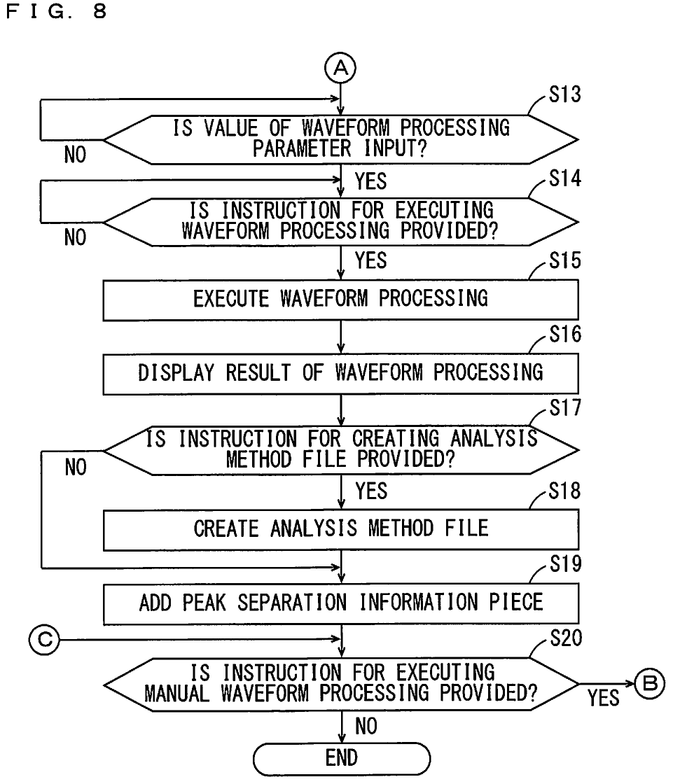

The display controller 14 determines whether a value of a waveform processing parameter has been input (the step S13 of FIG. 8). As shown in FIG. 12, in a case where values of “Slope,” “Width” and “Drift” are respectively input in the input fields 162 to 164, the waveform processing execution button 172 can be selected. The display controller 14 determines whether an instruction for executing the waveform processing has been provided (step S14). In the present example, whether the waveform processing execution button 172 has been operated with use of the operation unit 30 is determined. In a case here an instruction for executing the waveform processing has not been provided, determination of the step S14 is repeated.

When an instruction for executing the waveform processing is provided, the waveform processor 15 executes the waveform processing based on the values of “Slope,” “Width” and “Drift” that have been input in the input fields 162 to 164 of FIG. 12 with respect to the subject waveform data piece 200a. Thus, a result of waveform processing in regard to each peak of the subject waveform data piece 200a is obtained. The display controller 14 causes the display 40 to display a result of waveform processing in regard to each peak of the subject waveform data piece 200a. In the present example, as a result of waveform processing in regard to peaks “No. 1” to “No. 5” of the subject waveform data piece 200a, peak start points, peak end points, peak intensities (intensities of peak tops), peak areas, a peak separation method and so on are obtained. In the example of FIG. 13, a waveform processing result display window 177 showing a result of waveform processing in regard to each peak is displayed on the screen of the display 40. In FIG. 13, a peak area, a peak intensity and a peak separation method in regard to the peak “No. 2” are displayed in the waveform processing result display window 177. The user can cause the waveform processing result display window 177 to display a result of waveform processing in regard to another peak using the operation unit 30.

In the present example, as shown in FIG. 13, an analysis method file creation button 199 is displayed on the screen of the display 40. The display controller 14 determines whether an instruction for creating an analysis method file has been provided (step S17). In the present example, whether the analysis method file creation button 199 has been operated is determined.

In a case where an instruction for creating an analysis method file has been provided, the analysis method file creator 18 creates an analysis method file including values of a plurality of waveform processing parameters that are set in the waveform processing parameter setting window 161 as waveform processing conditions (step S18). In the present example, in a case where the user designates a value of a waveform processing parameter in the robustness information piece 174 of FIG. 11, an analysis method file including the designated value of the waveform processing parameter is created. The created analysis method file is stored in the storage 20.

Further, the information adder 17 adds values of one or a plurality of types of waveform processing parameters that are used in the waveform processing of each peak of the subject waveform data piece 200a and a result of waveform processing in the storage 20 as new peak separation information pieces (step S19). In this case, the information adder 17 also adds the shape of a peak corresponding to each peak separation information piece to the storage 20. In the example of FIG. 13, peak separation information pieces in regard to the peaks “No. 1” to “No. 5” are added to the storage 20 together with the shape of each peak.

In a case where considering that a result of waveform processing displayed on the screen of the display 40 is not a desired result of waveform processing, the user can manually correct the result of waveform processing of each peak of the subject waveform data piece 200a. In the present example, as shown in FIG. 13, a manual waveform processing button 182 is displayed on the screen of the display 40. In this case, the user operates the manual waveform processing button 182. The display controller 14 determines whether an instruction for executing manual waveform processing has been provided (step S20). In the present example, whether the manual waveform processing button 182 has been operated is determined.

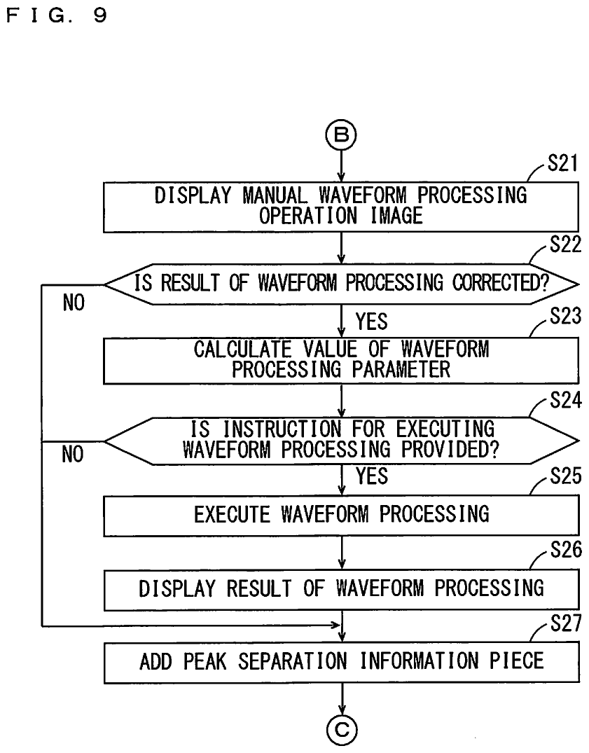

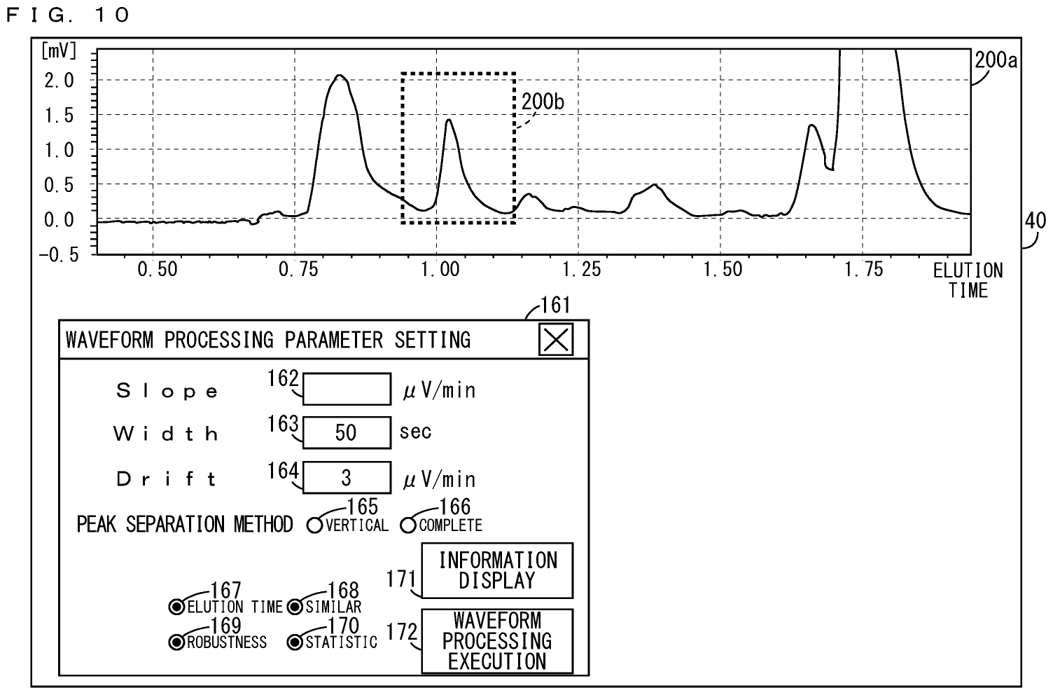

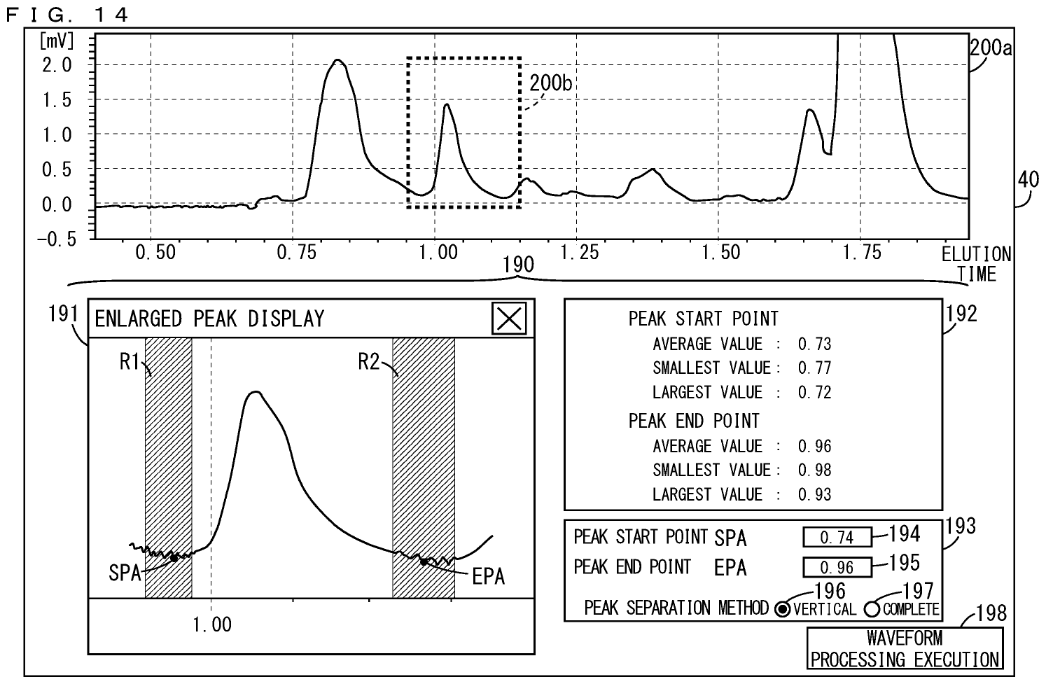

In a case where an instruction for executing the manual waveform processing has been provided, the display controller 14 causes the display 40 to display the manual waveform processing window 190 as shown in FIG. 14 (the step S21 of FIG. 9). In the example of FIG. 14, the manual waveform processing window 190 includes a peak display window 191, a statistic display window 192 and a correction value display window 193. In the peak display window 191, an enlarged diagram of the representative peak 200b is displayed, and a peak start point SPA and a peak end point EPA in a result of waveform processing obtained by the waveform processing of the step S15 are displayed. The peak start point SPA and the peak end point EPA can be corrected manually by an operation of the operation unit 30.

In the statistic display window 192, the average value, the smallest value and the largest value of the peak start point, and the average value, the smallest value and the largest value of the peak end point in regard to a plurality of selection peaks calculated by the statistic element 16 are displayed. In the peak display window 191, a start point setting range R1 and an end point setting range R2 are displayed. The start point setting range R1 represents the range of the peak start point calculated by the statistic element 16 from the smallest value to the largest value. The end point setting range R2 represents the range of the peak end point calculated by the statistic element 16 from the smallest value to the largest value.

The correction value display window 193 includes a peak start point display 194, a peak end point display 195 and selection buttons 196, 197. In the peak start point display 194, a value of a peak start point SPA is input automatically. In the peak end point display 195, a value of a peak end point EPA is input automatically. The selection button 196 is selected to designate vertical division as the peak separation method. The selection button 197 is selected to designate complete separation as the peak separation method.

The user can correct the peak start point SPA in the start point setting range R1 of the peak display window 191. Further, the user can correct the peak end point EPA in the end point setting range R2. In this case, the user can make reference to the statistic in the statistic display window 192. Further, the user can correct a value in the peak start point display 194 or a value in the peak end point display 195 in the correction value display window 193. In this case, the position of the peak start point SPA and the position of the peak end point EPA in the peak display window 191 are changed automatically. Further, the user can select one of the selection buttons 196, 197. Thus, the user can correct the peak separation method. In the example of FIG. 14, vertical division is designated as the peak separation method.

When a result of waveform processing is corrected in the manual waveform processing window 190, values of waveform processing parameters for acquirement of the corrected result of waveform processing are changed. The display controller 14 determines whether the result of waveform processing has been corrected by the manual waveform processing (step S22). In a case where the result of waveform processing has not been corrected by the manual waveform processing, the display controller 14 returns to the step S20.

In a case where the result of waveform processing has been corrected by the manual waveform processing in the step S22, the waveform processor 15 calculates values of waveform processing parameters for acquirement of the corrected result of waveform processing (step S23). In this case, the waveform processor 15 detects the values of the waveform processing parameters for acquirement of the result of waveform processing that is the same as or similar to the corrected result of waveform processing by searching through the plurality of peak separation information pieces stored in the storage 20.

As shown in FIG. 14, a waveform processing execution button 198 is displayed on the screen of the display 40. The user can provide an instruction for executing the waveform processing using a calculated value of a waveform processing parameter by operating the waveform processing execution button 198.

The display controller 14 determines whether an instruction for executing the waveform processing has been provided (step S24). In a case where an instruction for executing the waveform processing has not been provided, the waveform processor 15 returns to the step S20.

In a case where an instruction for executing the waveform processing is provided in the step S24, the waveform processor 15 executes the waveform processing on the subject waveform data piece 200a using the calculated values of the waveform processing parameter (step S25). Thus, the correspondence relationship between a value of a waveform processing parameter and a result of waveform processing in regard to each peak of the subject waveform data piece 200a is obtained as a peak separation information piece. The display controller 14 causes the display 40 to display the result of waveform processing obtained by the waveform processor 15 (step S26).

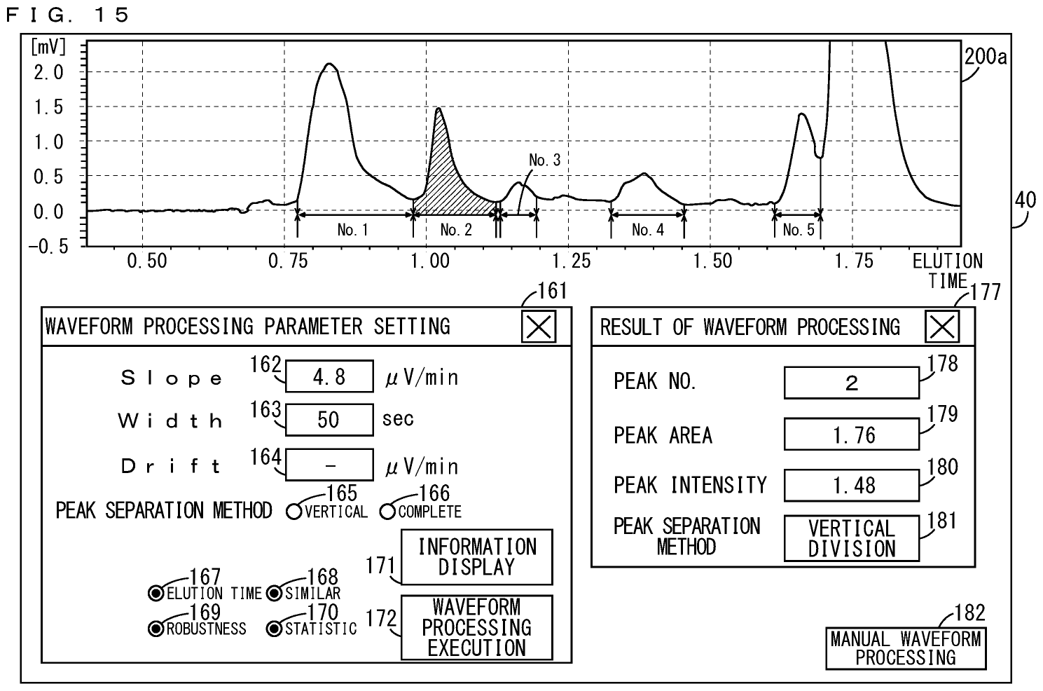

In the example of FIG. 15, similarly to FIG. 13, the waveform processing data piece 200a, the waveform processing parameter setting window 161 and the waveform processing result display window 177 are displayed on the screen of the display 40. In the waveform processing parameter setting window 161, values of waveform processing parameters for acquirement of a corrected result of waveform processing are displayed. In the waveform processing result display window 177, the corrected result of waveform processing is displayed.

The information adder 17 adds a peak separation information piece in regard to each peak obtained by the waveform processor 15 to the storage 20 (step S27). Thereafter, the display controller 14 returns to the step S20.

In the step S20, in a case where an instruction for executing the manual waveform processing is not provided, the behavior of the waveform processing assistance device 10 of FIG. 6 ends.

In a case where an appropriate value of a waveform processing parameter is to be set for any section of the subject waveform data piece 200a, the process of FIGS. 7 to 9 is executed as the user changes the section of the representative peak 200b.

### (5) Effects of Embodiments

With the waveform processing assistance device 10 according to the present embodiment, the shapes of a plurality of selection peaks 173a and a plurality of selection peak separation information pieces 173b are displayed in the display 40. In this case, the user can identify values of waveform processing parameters corresponding to an appropriate result of waveform processing by viewing the shapes of the plurality of displayed selection peaks 173a and the plurality of displayed selection peak separation information pieces 173b. Further, a robustness information piece 174 is displayed in the display 40. Thus, the user can identify values of waveform processing parameters having high robustness by viewing the robustness information piece. As a result, values of waveform processing parameters that have high robustness and with which an appropriate result of waveform processing can be obtained can be determined easily.

Further, one or a plurality of peak separation information pieces that satisfy a predetermined selection condition are selected by the first selector 12a, and the shapes of one or a plurality of selection peaks 173a and selection peak separation information pieces 173b are displayed in the display 40. Thus, the user can easily identify appropriate values of waveform processing parameters for separation of a desired peak from a waveform data piece obtained by the analysis device 2.

Further, one or a plurality of peak separation information pieces in regard to one or a plurality of peaks having a shape similar to the shape of a representative peak 200b in a subject waveform data piece 200a are selected by the second selector 12b, and the shapes of the one or plurality of selection peaks 173a and the selection peak separation information pieces 173b are displayed in the display 40. Thus, the user can easily identify appropriate values of waveform processing parameters for separation of a desired peak from the waveform data piece obtained by the analysis device 2.

Further, the second selector 12b selects one or a plurality of peaks having a shape similar to the shape of a representative peak 200b using the clustering method such as hierarchical clustering. Thus, one or a plurality of peaks having a shape that is the same as or similar to the shape of the representative peak 200b are easily and appropriately selected.

Further, the information adder 17 adds a new peak separation information piece obtained by the waveform processor 15 to the storage 20. Thus, because the number of a plurality of various peak separation information pieces stored in the storage 20 increases cumulatively, values of waveform processing parameters which have high robustness and with which an appropriate result of waveform processing can be obtained can be determined with high accuracy.

Further, the statistic element 16 calculates a statistic of a plurality of results of waveform processing in regard to any peak of a plurality of waveform processing data pieces obtained by an analysis that is performed multiple times in regard to the same sample. Further, the statistic calculated by the statistic element 16 is displayed in the display 40 by the display controller 14. In this case, the user can identify appropriate values of waveform processing parameters based on the statistic of the plurality of results of waveform processing.

Further, the determiner 13 calculates reproduciability of each value of a waveform processing parameter of a plurality of selection peak separation information pieces 173b and calculates robustness of the value of the waveform processing parameter based on the calculated reproduciability. In this case, even when the shapes of a plurality of waveform data pieces obtained by an analysis that is performed multiple times in regard to the sample are changed, in a case where reproduciability of a result of waveform processing is high, a variation in result of waveform processing is small. Therefore, robustness of each value of a waveform processing parameter can be easily determined based on reproduciability of a result of waveform processing corresponding to each value of a waveform processing parameter.

Further, in a case where the user designates a value of a waveform processing parameter in the robustness information piece 174, an analysis method file including the designated value of the waveform processing parameter is created and stored in the storage 20. Thus, in a case where an analysis is performed in regard to the same sample, it is possible to easily determine a condition of a sample analysis performed by the analysis device 2 and a condition of waveform processing fora waveform data piece using the analysis method file stored in the storage 20.

### (6) Other Embodiments

While a robustness information piece 174 for determination of an appropriate value of “Slope” which is one type of a waveform processing parameter by a user is displayed in the example of behavior of the above-mentioned embodiment, a robustness information piece for determination of appropriate values of two or more types of waveform processing parameters by the user may be displayed.

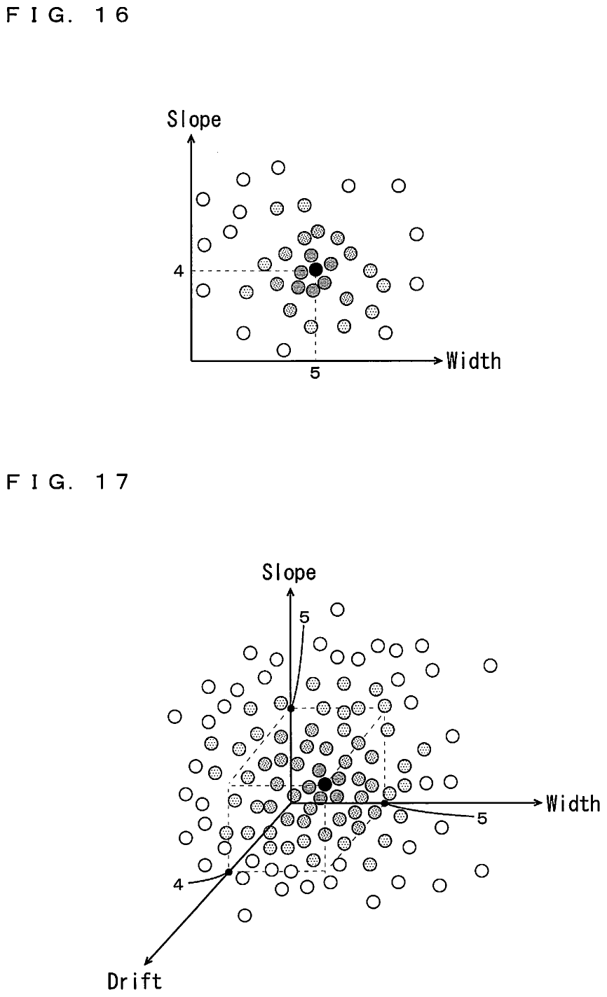

FIG. 16 is a diagram showing an example of a robustness information piece representing robustness of values of two types of waveform processing parameters. The abscissa of FIG. 16 indicates a value of “Slope,” and the ordinate indicates a value of “Width.” In the robustness information piece of FIG. 16, reproduciability of results of waveform processing in regard to the combinations of a value of “Slope” and a value of “Width” are indicated by shading in dots. The combination of values of the waveform processing parameters having the highest robustness is indicated by a black dot. The combinations of values of the waveform processing parameters having intermediate robustness are indicated by dots having dotted pattern. The combinations of values of the waveform processing parameters having the lowest robustness are indicated by white dots. In the example of FIG. 16, the user can determine that the combination has high robustness in a case where the value of “Slope” is 5 and the value of “Width” is 4.

FIG. 17 is a diagram showing an example of a robustness information piece representing robustness of values of three types of waveform processing parameters. The robustness information piece of FIG. 17 has first to three axes being orthogonal to one another. The first to third axes respectively indicate a value of “Slope,” a value of “Width” and a value of “Drift.” In the robustness information piece of FIG. 17, similarly to the robustness information piece of FIG. 16, reproduciability of results of waveform processing in regard to combinations of values of three types of the waveform processing parameters are indicated by shading in dots. In the example of FIG. 17, the user can determine that the combination has high robustness in a case where the value of “Slope” is 5, the value of “Width” is 5 and the value of “Drift” is 4.

While being an elution time in the above-mentioned embodiment, a selection condition used by the first selector 12a may include at least one of a peak type (a leading peak and a tailing peak, for example), a peak area, a peak intensity, peak resolution and a value of a waveform processing parameter in a waveform data piece. Thus, the shapes of one or a plurality of peaks having specific attributes or specific values of a waveform processing parameter are displayed in the display 40. In this case, the user can easily identify a value of a waveform processing parameter for acquirement of a desired result of waveform processing.

While including the waveform processor 15 as a function in the above-mentioned embodiment, the waveform processing assistance device 10 does not have to include the waveform processor 15 in a case where a waveform processing device is provided separately from the waveform processing assistance device 10.

While the display 40 is provided in the control device 1 in the above-mentioned embodiment, a display 21 of the analysis device 2 may be used as a function of the display 40. Further, while the storage 20 is provided in the control device 1, the waveform processing assistance device 10 may include the storage 20 as a function.

### (7) Aspects

It is understood by those skilled in the art that the plurality of above-mentioned illustrative embodiments are specific examples of the below-mentioned aspects.

(Item 1) A waveform processing assistance device according to one aspect that assists waveform processing of separating a peak from a waveform data piece representing an analysis result of an analysis device based on a value of a waveform processing parameter using a display, may include an acquirer that acquires a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter, a determiner that determines robustness of each value of the waveform processing parameter based on the plurality of peak separation information pieces acquired by the acquirer, and a display controller that causes the display to display the plurality of peak separation information pieces acquired by the acquirer and a robustness information piece representing robustness of each value of the waveform processing parameter that is calculated by the determiner.

With the waveform processing assistance device according to one aspect, the correspondence relationships between a plurality of values of waveform processing parameters and a plurality of results of waveform processing are displayed in the display as a plurality of peak separation information pieces. Thus, the user can identify values of waveform processing parameters corresponding to an appropriate result of waveform processing by viewing the plurality of displayed peak separation information pieces. Further, a robustness information piece representing robustness of each value of a waveform processing parameter is displayed in the display. Thus, the user can identify values of waveform processing parameters having high robustness by viewing the robustness information piece. As a result, values of waveform processing parameters that have high robustness and with which an appropriate result of waveform processing can be obtained can be determined easily.

(Item 2) The waveform processing assistance device according to item 1, wherein the acquirer may include a first selector that selects one or a plurality of peak separation information pieces that satisfy a predetermined selection condition out of the plurality of peak separation information pieces, and the display controller may cause the display to display shapes of one or a plurality of peaks respectively corresponding to the one or plurality of peak separation information pieces selected by the first selector.

With the waveform processing assistance device according to item 2, the user can easily and quickly identify values of waveform processing parameters with which an appropriate result of waveform processing can be obtained based on the shapes of one or a plurality of displayed peaks and a displayed result of waveform processing.

(Item 3) The waveform processing assistance device according to item 2, wherein the selection condition may include at least one of a peak position, a peak type, a peak area, a peak intensity, a peak resolution and a value of a waveform processing parameter in a waveform data piece.

With the waveform processing assistance device according to item 3, a peak separation information piece in regard to one or a plurality of peaks that have specific attributes or specific values of waveform processing parameters is displayed in the display. Thus, the user can easily identify values of waveform processing parameters for acquirement of a desired result of waveform processing.

(Item 4) The waveform processing assistance device according to item 2 or 3, wherein the acquirer may include a second selector that selects one or a plurality of peak separation information pieces corresponding to one or a plurality of peaks having a shape that is same as or similar to a shape of one peak in a waveform data piece obtained by the analysis device out of the plurality of peak separation information pieces, and the display controller may cause the display to display shapes of one or a plurality of peaks respectively corresponding to one or a plurality of peak separation information pieces selected by the second selector.

With the waveform processing assistance device according to claim 4, one or a plurality of peaks having the shapes that are the same as or similar to the shape of one peak are displayed in the display. Thus, the user can easily identify appropriate values of waveform processing parameters for separation of a desired peak from a waveform data piece obtained by the analysis device.

(Item 5) The waveform processing assistance device according to item 4, wherein the second selector may extract a feature from a plurality of peaks corresponding to the plurality of peak separation information pieces and may select one or a plurality of peaks having a shape that is same as or similar to a shape of the one peak using a clustering method that is based on the extracted feature.

With the waveform processing assistance device according to item 5, one or a plurality of peaks having the shapes that are the same as or similar to the shape of one peak are easily and appropriately selected.

(Item 6) The waveform processing assistance device according to any one of items 1 to 5, may further include a storage that stores the plurality of peak separation information pieces, a waveform processor that executes the waveform processing on a waveform data piece that is different from the one or plurality of waveform data pieces, and an information adder that adds a new peak separation information piece including a result of waveform processing obtained by the waveform processor to the storage.

With the waveform processing assistance device according to claim 6, because the number of a plurality of peak separation information pieces stored in the storage increases cumulatively, accuracy of determination of a value of a waveform processing parameter is improved.

(Item 7) The waveform processing assistance device according to item 6, wherein the waveform processor may generate a plurality of peak separation information pieces in regard to each peak by executing waveform processing in regard to a peak corresponding to one or a plurality of peak separation information pieces acquired by the acquirer based on a plurality of values of the waveform processing parameter, and the information adder may add a peak separation information piece including the plurality of results of waveform processing generated by the waveform processor to the storage.

With the waveform processing assistance device according to item 7, various peak separation information pieces are stored in the storage. Thus, the user can determine a value of a waveform processing parameter which has high robustness and with which an appropriate result of waveform processing can be obtained with high accuracy.

(Item 8) The waveform processing assistance device according to any one of claims 1 to 7, may further include a statistic element that calculates a statistic of a plurality of results of waveform processing obtained by waveform processing of a plurality of waveform data pieces obtained by an analysis performed multiple times in regard to a same sample, wherein the display controller may cause the display to display the statistic calculated by the statistic element.

With the waveform processing assistance device according to claim 8, the user can identify an appropriate value of a waveform processing parameter based on a statistic of a plurality of results of waveform processing.

(Item 9) The waveform processing assistance device according to any one of claims 1 to 7, wherein the determiner may calculate reproduciability of a result of waveform processing corresponding to each value of the waveform processing parameter based on the plurality of peak separation information pieces acquired by the acquirer, and may determine the robustness based on the calculated reproduciability.

With the waveform processing assistance device according to claim 9, even in a case where the shapes of a plurality of waveform data pieces obtained by an analysis that is performed multiple times with respect to the same sample are changed, when reproduciability of a result of waveform processing is high, a variation in results of waveform processing is small. Therefore, robustness of each value of a waveform processing parameter can be easily determined based on reproduciability of a result of waveform processing corresponding to each value of a waveform processing parameter.

(Item 10) The waveform processing assistance device according to any one of items 1 to 9, may further include a creator that creates an analysis method file including a condition of a sample analysis performed by the analysis device and a condition of waveform processing of a waveform data piece that is obtained by the analysis device, wherein the display controller may display the robustness information piece such that a value of the waveform processing parameter is designatable, and the creator may create an analysis method file including a value of the waveform processing parameter designated in the robustness information piece.

With the waveform processing assistance device according to claim 10, in a case where the user designates a value of a waveform processing parameter in a robustness information piece, an analysis method file including the designated value of a waveform processing parameter is created. Thus, in a case where an analysis is performed in regard to the same sample, a condition of a sample analysis to be performed by the analysis device and a condition of waveform processing for a waveform data piece can be easily determined with use of the created analysis method.

(Item 11) A waveform processing assistance method according to another aspect of assisting waveform processing of separating a peak from a waveform data piece representing an analysis result of an analysis device based on a value of a waveform processing parameter using a display may include acquiring a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter, determining robustness of each value of the waveform processing parameter based on the plurality of acquired peak separation information pieces, and causing the display to display the plurality of acquired peak separation information pieces and a robustness information piece representing robustness of each value of the determined waveform processing parameter.

With the waveform processing assistance method according to another aspect, the correspondence relationships between a plurality of values of waveform processing parameters and a plurality of results of waveform processing are displayed in the display as a plurality of peak separation information pieces. Thus, the user can identify a value of a waveform processing parameter corresponding to an appropriate result of waveform processing by viewing the plurality of displayed peak separation information pieces. Further, a robustness information piece representing robustness of each value of a waveform processing parameter is displayed in the display. Thus, the user can identify a value of a waveform processing parameter having high robustness by viewing the robustness information piece. As a result, a value of a waveform processing parameter that has high robustness and with which an appropriate result of waveform processing can be obtained can be determined easily.

(Item 12) The waveform processing assistance method according to item 11, wherein the acquiring may include selecting one or a plurality of peak separation information pieces that satisfy a predetermined selection condition out of the plurality of peak separation information pieces, and the causing the display to display may include causing the display to display shapes of one or a plurality of peaks respectively corresponding to the one or plurality of selected peak separation information pieces.

With the waveform processing assistance method according to item 12, the user can easily and quickly identify a value of a waveform processing parameter with which an appropriate result of waveform processing can be obtained based on the shapes of one or a plurality of displayed peaks and a displayed result of waveform processing.

(Item 13) The waveform processing assistance method according to item 11 or 12, wherein the acquiring may include selecting one or a plurality of peak separation information pieces corresponding to one or a plurality of peaks having a shape that is same as or similar to a shape of one peak in a waveform data piece obtained by the analysis device out of the plurality of peak separation information pieces, and the causing the display to display may include causing the display to display shapes of one or a plurality of peaks respectively corresponding to the one or plurality of peak separation information pieces acquired by the acquiring.

With the waveform processing assistance method according to item 13, one or a plurality of peaks having shapes that are the same as or similar to the shape of one peak are displayed in the display. Thus, the user can easily identify an appropriate value of a waveform processing parameter for separation of a desired peak from a waveform data piece obtained by the analysis device.

(Item 14) The waveform processing assistance method according to any one of items 11 to 13 nay further include storing the plurality of peak separation information pieces, executing the waveform processing on a waveform data piece that is different from the one or plurality of waveform data pieces, and adding and storing a new peak separation information piece including a result of waveform processing obtained by waveform processing of the different waveform data piece.

With the waveform processing assistance method according to claim 14, because the number of a plurality of peak separation information pieces stored in the storage increases cumulatively, accuracy of determination of values of waveform processing parameters is improved.

(Item 15) The waveform processing assistance method according to any one of items 11 to 14, wherein the determining robustness may include calculating reproduciability of a result of waveform processing corresponding to each value of the waveform processing parameter based on the plurality of acquired peak separation information pieces and determining the robustness based on the calculated reproduciability.

With the waveform processing assistance method according to item 15, even in a case where the shapes of a plurality of waveform processing data pieces obtained by an analysis that is performed multiple times in regard to the same sample are changed, when reproduciability of a result of waveform processing is high, a variation in results of waveform processing is small. Therefore, robustness of each value of a waveform processing parameter can be easily determined based on reproduciability of a result of waveform processing corresponding to each value of a waveform processing parameter.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A waveform processing assistance device that assists waveform processing of separating a peak from a waveform data piece representing an analysis result of an analysis device based on a value of a waveform processing parameter using a display, comprising:
an acquirer that acquires a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter;
a determiner that determines robustness of each value of the waveform processing parameter based on the plurality of peak separation information pieces acquired by the acquirer; and
a display controller that causes the display to display the plurality of peak separation information pieces acquired by the acquirer and a robustness information piece representing robustness of each value of the waveform processing parameter that is calculated by the determiner.

2. The waveform processing assistance device according to claim 1, wherein
the acquirer includes a first selector that selects one or a plurality of peak separation information pieces that satisfy a predetermined selection condition out of the plurality of peak separation information pieces, and
the display controller causes the display to display shapes of one or a plurality of peaks respectively corresponding to the one or plurality of peak separation information pieces selected by the first selector.

3. The waveform processing assistance device according to claim 2, wherein
the selection condition includes at least one of a peak position, a peak type, a peak area, a peak intensity, a peak resolution and a value of a waveform processing parameter in a waveform data piece.

4. The waveform processing assistance device according to claim 2, wherein
the acquirer includes a second selector that selects one or a plurality of peak separation information pieces corresponding to one or a plurality of peaks having a shape that is same as or similar to a shape of one peak in a waveform data piece obtained by the analysis device out of the plurality of peak separation information pieces, and
the display controller causes the display to display shapes of one or a plurality of peaks respectively corresponding to one or a plurality of peak separation information pieces selected by the second selector.

5. The waveform processing assistance device according to claim 4, wherein
the second selector extracts a feature from a plurality of peaks corresponding to the plurality of peak separation information pieces and selects one or a plurality of peaks having a shape that is same as or similar to a shape of the one peak using a clustering method that is based on the extracted feature.

6. The waveform processing assistance device according to claim 1, further comprising:
a storage that stores the plurality of peak separation information pieces;
a waveform processor that executes the waveform processing on a waveform data piece that is different from the one or plurality of waveform data pieces; and
an information adder that adds a new peak separation information piece including a result of waveform processing obtained by the waveform processor to the storage.

7. The waveform processing assistance device according to claim 6, wherein
the waveform processor generates a plurality of peak separation information pieces in regard to each peak by executing waveform processing in regard to a peak corresponding to one or a plurality of peak separation information pieces acquired by the acquirer based on a plurality of values of the waveform processing parameter, and
the information adder adds a peak separation information piece including the plurality of results of waveform processing generated by the waveform processor to the storage.

8. The waveform processing assistance device according to claim 1, further comprising a statistic element that calculates a statistic of a plurality of results of waveform processing obtained by waveform processing of a plurality of waveform data pieces obtained by an analysis performed multiple times in regard to a same sample, wherein
the display controller causes the display to display the statistic calculated by the statistic element.

9. The waveform processing assistance device according to claim 1, wherein
the determiner calculates reproduciability of a result of waveform processing corresponding to each value of the waveform processing parameter based on the plurality of peak separation information pieces acquired by the acquirer, and determines the robustness based on the calculated reproduciability.

10. The waveform processing assistance device according to claim 1, further comprising a creator that creates an analysis method file including a condition of a sample analysis performed by the analysis device and a condition of waveform processing of a waveform data piece that is obtained by the analysis device, wherein
the display controller displays the robustness information piece such that a value of the waveform processing parameter is designatable, and
the creator creates an analysis method file including a value of the waveform processing parameter designated in the robustness information piece.

11. A waveform processing assistance method of assisting waveform processing of separating a peak from a waveform data piece representing an analysis result of an analysis device based on a value of a waveform processing parameter using a display, including:
acquiring a correspondence relationship between a plurality of values of a waveform processing parameter and a plurality of results of waveform processing as a plurality of peak separation information pieces in regard to a plurality of peaks that are separated from one or a plurality of waveform data pieces based on the plurality of values of the waveform processing parameter;
determining robustness of each value of the waveform processing parameter based on the plurality of acquired peak separation information pieces; and
causing the display to display the plurality of acquired peak separation information pieces and a robustness information piece representing robustness of each value of the determined waveform processing parameter.

12. The waveform processing assistance method according to claim 11, wherein
the acquiring includes selecting one or a plurality of peak separation information pieces that satisfy a predetermined selection condition out of the plurality of peak separation information pieces; and
the causing the display to display includes causing the display to display shapes of one or a plurality of peaks respectively corresponding to the one or plurality of selected peak separation information pieces.

13. The waveform processing assistance method according to claim 11, wherein
the acquiring includes selecting one or a plurality of peak separation information pieces corresponding to one or a plurality of peaks having a shape that is same as or similar to a shape of one peak in a waveform data piece obtained by the analysis device out of the plurality of peak separation information pieces, and
the causing the display to display includes causing the display to display shapes of one or plurality of peaks respectively corresponding to the one or plurality of peak separation information pieces acquired by the acquiring.

14. The waveform processing assistance method according to claim 11, further including:
storing the plurality of peak separation information pieces;
executing the waveform processing on a waveform data piece that is different from the one or plurality of waveform data pieces; and
adding and storing a new peak separation information piece including a result of waveform processing obtained by waveform processing of the different waveform data piece.

15. The waveform processing assistance method according to claim 11, wherein
the determining robustness includes calculating reproduciability of a result of waveform processing corresponding to each value of the waveform processing parameter based on the plurality of acquired peak separation information pieces and determining the robustness based on the calculated reproduciability.
